(19) United States
(12) Patent Application Publication
(10) Pub. No.: US 2011/0003141 A1
(43) Pub. Date: Jan. 6, 2011

(54) MICROSTRUCTURED MATERIAL AND PROCESS FOR ITS MANUFACTURE

(76) Inventor: Arkady Garbar, Minnetonka, MN (US)

Correspondence Address: FISH & RICHARDSON P.C. (TC), PO BOX 1022, MINNEAPOLIS, MN, 55440-1022, US

(21) Appl. No.: 12/809,193

(22) PCT Filed: Dec. 19, 2008
(86) PCT No.: PCT/US08/87770

§ 371 Date: Sep. 21, 2010

Related U.S. Application Data
(62) Division of application No. 61/015,483, filed on Dec. 20, 2007.
Application No. 61/015,483 is a division of application No. 61/061,890, filed on Jun. 16, 2008.

(51) Int. Cl. B32B 5/16; C25D 15/00

(52) U.S. Cl. 428/328; 205/109; 977/902

(57) ABSTRACT

A micro-structured article is disclosed comprising a free-standing network of interconnected traces surrounding randomly-shaped cells wherein the interconnected traces comprise at least partially-joined nanoparticles. In a preferred embodiment, the nanoparticles comprise a conductive metal. The article is preferably formed by coating a nanoparticle-containing emulsion onto a substrate and drying the emulsion. The nanoparticles self-assemble into the network pattern which is subsequently removed from the substrate. A preferred method of removing the network from the substrate comprises the steps of electroplating the traces and subsequently exposing the traces to acid to release the network from the substrate.

### TECHNICAL FIELD

This invention relates to the field of microstructured materials and processes of manufacturing microstructured materials.

### BACKGROUND

Materials having controlled microstructures have broad consumer and industrial uses. Specifically, thin contiguous sheets of selected materials having controlled porosity are used in a variety of applications. Both the sheet and the pores may serve various purposes. For instance, fabrics and textiles may be generated out of woven materials to offer mechanical support, chemical separation, thermal isolation, or ornamental use. Various materials may be used to define the material network, for instance natural organic materials are used in conventional clothing. Alternatively, inorganic materials may be used, such as metals, in various porous consumer applications, such as a metal mesh in a conventional screen insert in a window or door. Further, a wide variety of industrial uses exist for metal meshes, including use as size-separating filters, electromagnetic interference filters, substrates, electrodes, etc.

Means of controlling the structure of the network, including mesh size and distributions of size (width, thickness), mesh materials, mesh connectivity, mesh pore size and pore size distributions, are varied, and often costly. Highly intricate fabrication technologies, such as photolithography, or printing and electroforming, are capable of precise geometric structure formation, but at great cost. Lower cost manufacturing technologies exist, such as weaving or stamping, but are limited in geometric control and precision or material properties.

There thus exists a need for improved microstructured materials having simplified and more economical processes of fabrication.

### SUMMARY

Disclosed herein is a microstructured article and process for its fabrication. The article comprises a free-standing network of interconnected traces surrounding randomly-shaped cells wherein the interconnected traces comprise at least partially joined nanoparticles. The nanoparticle-based thin patterned structure has, macroscopically, an interconnected two-dimensional network pattern, and, microscopically, a series of connected nanoparticles defining the pattern of the network. Such a patterned structure will also be referred to herein for simplicity as a “mesh” even though the pattern is random and not formed by interconnecting vertical and horizontal members. Such a mesh can be referred to as “free-standing” or “self-supporting” or “substrate-free,” all referring to the fact that no monolithic substrate (such as a uniform sheet web) is integrated into the article.

A further aspect of the microstructured material relates to the nanoparticles of metal that form the mesh or patterned structure. While particles having an average particle size of less than about 100 nanometers are preferred, larger particles having average particle sizes up to about three microns may be used in some cases. All particles, regardless of size, used to form the patterned structures of the invention will be referred to herein as “nanoparticles”. The nanoparticles may be sintered into intimate contact with one another to define a strongly interconnected network. These metal networks may be further characterized by low sheet resistance (for instance, <10,000 Ohms/sq), high transparency to visible light (for instance, >50%), low areal mass density (as little as 1 g/m²), controlled and small pores (between 1 um² and 1 mm²), and small network traces (<100 um widths, <100 um thicknesses). Typical networks will be disordered in structure, having random-shaped cells of similar size in generally round or polygon shapes.

In some cases it may be desirable to include a filler material within the cells of the mesh such as is described in co-pending application (Attorney Docket No. ______) filed on even date herewith, the disclosure of which is incorporated herein by reference.

A further embodiment is a mesh wherein the nanoparticles have an additional coating or coatings of material, such as may be accomplished by electroplating a layer of a second metal (similar or dissimilar to the nanoparticle material) on or completely around the nanoparticle network. Alternatively, a layer of passivating material may be used, such as an oxide or organic coating. Further, an adhesive may be used.

A further embodiment consists of a two dimensional network mesh with an asymmetry in properties on two surfaces. For instance, one side may have a high degree of planarity in its surface and high specular optical reflection and a second side have a higher degree of disorder to its topography, and lower specular optical reflection but higher diffusive reflection. Also, two sides may be of different colors.

Another aspect of the invention related to a process of fabricating a microstructured material. US20050214480 and WO2006/135735 describe an emulsion drying process to form transparent conductive coatings comprising nanoparticles on a substrate. Following such a process or related processes, further steps may be carried out to fabricate a free standing microstructured material.

One embodiment of the process releases the preexisting mesh from a substrate by chemically removing or deactivating adhesive elements binding the mesh to the substrate. For instance, an acid or base may be used to remove an organic adhesive holding a metal mesh on a substrate. Alternatively adhesive elements may be rendered inactive or destroyed by thermal process or photoexcitation.

A further embodiment releases a preexisting mesh from a substrate by chemically removing the substrate. For instance, an acid or base may be used to remove an organic substrate from the metal mesh.

A further embodiment releases a preexisting mesh from a substrate by transferring it from one substrate to a second or further substrate, and then releasing the second or further substrates. For instance, a substrate having a flat surface with optimal properties for pattern formation or a substrate capable of high through-put processing may be initially used to form the network pattern or mesh, and then the mesh is transferred to a second substrate that is coated, for instance, with an adhesive, to transfer the mesh subsequently, such as by release of the adhesive.

A further embodiment mechanically pulls the mesh off an initial substrate, with or without additional processes as described above. To facilitate mechanical removal of the mesh by processes such as scraping, peeling, knife-separating and the like, the formed mesh may be partially released or weakened in its adhesion to a substrate by chemical processes or the mesh can be formed on an initial substrate to which it has low adhesion, and subsequently completely removed by “peeling” it from the substrate.

A further embodiment induces mechanical stresses into the mesh to assist or force removal, such as by mesh shrinkage during sintering or delamination driven by differences in the thermal coefficient of expansion between the mesh and the substrate.

A further embodiment is the use of a chemical environment to both coat and remove the mesh, either sequentially or simultaneously. For instance, an acidic electroplating bath may be used to simultaneously coat the network mesh and reduce adhesive forces holding the network to the substrate.

After removal from the substrate, the mesh can be elongated or otherwise deformed so as to change the shape of the cells. For example, elongation can orient and increase the aspect ratio of the cells in the mesh. This can induce useful enhancements in conduction along one axis, as well as possibly useful increases in electrical anisotropy.

The free-standing microstructured material has numerous product applications. The material may be used as a transparent conductor, specifically as one or more of: an electrode, an EMI filter, an antenna, a ground plane, a heat sink, a heater, an electronic material filter, or a heat exchanger.

The material may be used as a mechanical filter, for example, to separate materials or maintain the separation of materials or different regions of a singe material that have different effective sizes or properties. Such a filter may be used in various operating media, including vacuum, air, water, solvents, and fluids more generally.

Such a material may be used as a heater or heat exchanger, with high effective surface area for heat transfer between the mesh and an open media, such as vacuum, air, water, solvents and fluids more generally.

Such a material may be used simultaneously as an EMI filter and an air or fluid vent, such as in the case of a metal mesh being used to complete a faraday cage around an object to prevent EMI transmission across a barrier, but simultaneously allow air or fluid flow to allow thermal transport across the same region.

Such a material may be used as an electronic filter, by applying constant or time varying voltages to it to control material flow to or through the filter.

The above summary is not intended to describe each disclosed embodiment or every implementation of the present invention. The Figures and the detailed description that follow more particularly exemplify illustrative embodiments.

### BRIEF DESCRIPTION OF THE DRAWINGS

FIG. 1a is a photograph of one embodiment of the mircostructured article of the invention.

FIG. 1b is the embodiment of FIG. 1a at higher magnification to show the pattern of the microstructured article.

FIG. 2 is a microscope image taken with backlighting of one embodiment of the microstructured article.

FIG. 3 is a microscope image taken capturing a reflected image of one embodiment of the microstructured article.

FIG. 4 is a microscope image taken capturing a reflected image from a second surface of one embodiment of the microstructured article.

FIG. 5 illustrates the steps of one embodiment of the process for making the microstructured article.

FIG. 6 is a schematic drawing illustrating an embodiment of the process for making the microstructured article.

FIG. 7 is a schematic drawing illustrating another embodiment of the process for making the microstructured article.

### DETAILED DESCRIPTION

The microstructured material of the invention is a nanoparticle-based thin mesh, having, macroscopically, a two-dimensional network pattern of interconnected traces forming randomly-shaped cells between the traces, and microscopically, a series of connected nanoparticles defining the traces of the network. Such a mesh can be referred to as “free-standing” or “self-supporting” or “substrate-free,” all referring to the fact that no monolithic substrate (such as a uniform sheet web) is integrated into the article.

Such materials may be formed by an improvement and extension of the process of forming transparent conductive coatings on substrates described in US20050214480 and WO2006/135735, the disclosures of which are incorporated herein by reference. As described in the aforementioned patent applications, a process of using an emulsion with additives such as nanoparticles may be used to fabricate a network mesh on a substrate under controlled conditions. In preferred configurations, such a network may be comprised of metallic nanoparticles, subsequently sintered, thermally or chemically, to interconnect the nanoparticles to form a interconnected mesh, and optionally electroplated to enhance conductivity.

In accordance with one embodiment of the process of the present invention, such a mesh is subsequently processed, such as by electroplating, to add similar or dissimilar materials to the mesh and exposed to an acid to release binding agents holding the substrate in place, to generate a free standing mesh. As described above, a free standing mesh will have numerous benefits for application for which a substrate-bound mesh may be prohibitive or limiting.

Additional benefits may also include the removal of materials not connected to the rest of the mesh, such as isolated nanoparticles formed in an emulsion coating process in the middle of otherwise open/transparent cells. Such nanoparticles add to film haze and reduce transparency, but do not add appreciably to film electrical or thermal sheet conduction properties. Generation of a free-standing mesh in this fashion reduces the amount of such defects in the final article. Similarly, poorly bound materials along the edges of network traces will be removed, and may improve transparency/haze without appreciably degrading conductance. Further, even network traces that are otherwise complete and intact, but which do not reach to another network “node” (a network strut connected to the network on only one end), may be preferentially removed from a network in this fashion.

Resultant films will also be lighter-weight, consume less volume, and allow intimate electrical, thermal or chemical connection from both opposing sides of the network. The process also allows reusable substrates, so less material is consumed in fabrication of the mesh itself, and allows for use of a substrate for coating that may be optimized for coating and subsequently, a separate substrate (or free standing film) with properties optimized for end use application may be used.

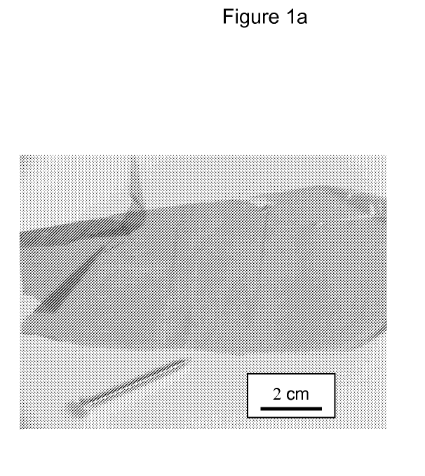

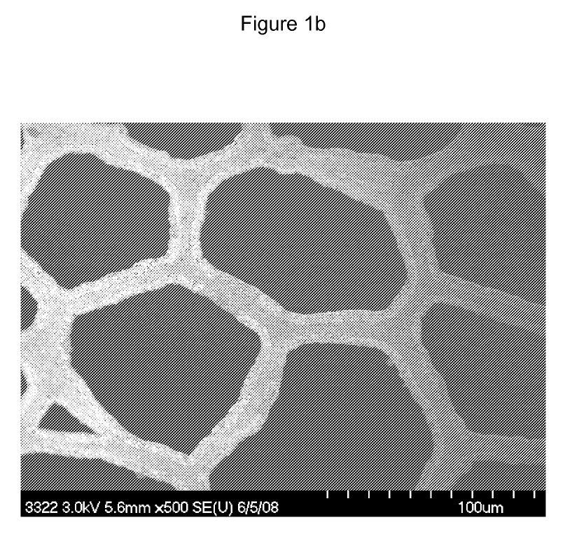

Referring now to the figures, FIGS. 1a and 1b are optical images of an embodiment of the microstructured mesh having 84% visible light transparency, 3% haze, and 0.04 Ohms/sq sheet resistance.

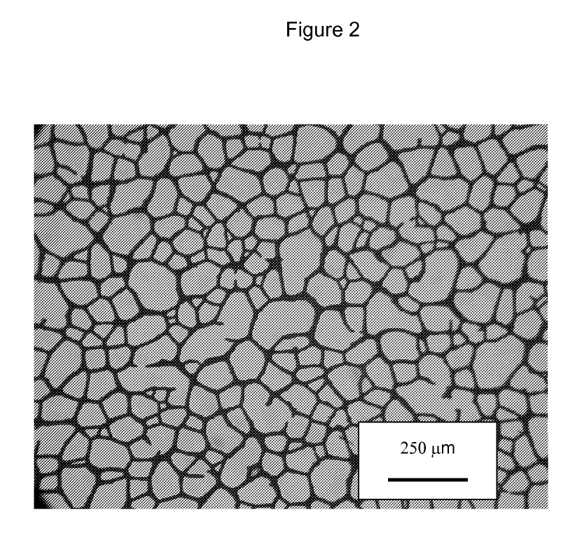

As can be seen in FIG. 2, a optical micrograph taken in transmission mode (the microstructured mesh casting a shadow on the imaging system, with transmitted light visible in the cells of the mesh), one embodiment of the invention generates approximately 100 um size, randomly-shaped cells in the network mesh, with approximately 20 um wide network lines or traces that are approximately 20 um thick.

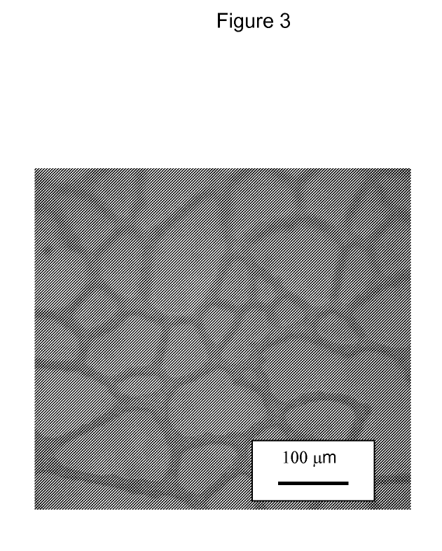

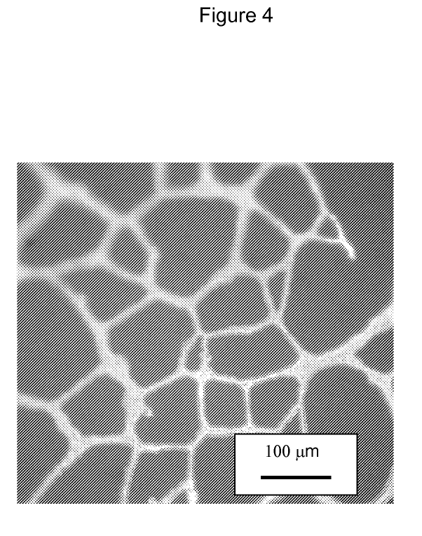

At higher magnification, images taken in reflection mode (the microstructred mesh reflecting back to the imaging system specularly reflected light) as shown in FIGS. 3 and 4 indicate that the reflected image of two opposing surfaces of the same mesh can have large differences in specular reflection.

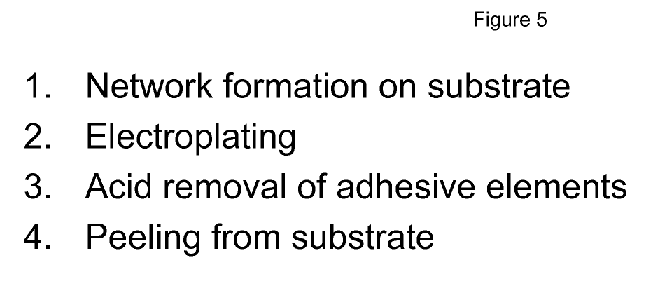

One embodiment of the process used to make the free-standing microstructured mesh is described by the steps in FIG. 5.

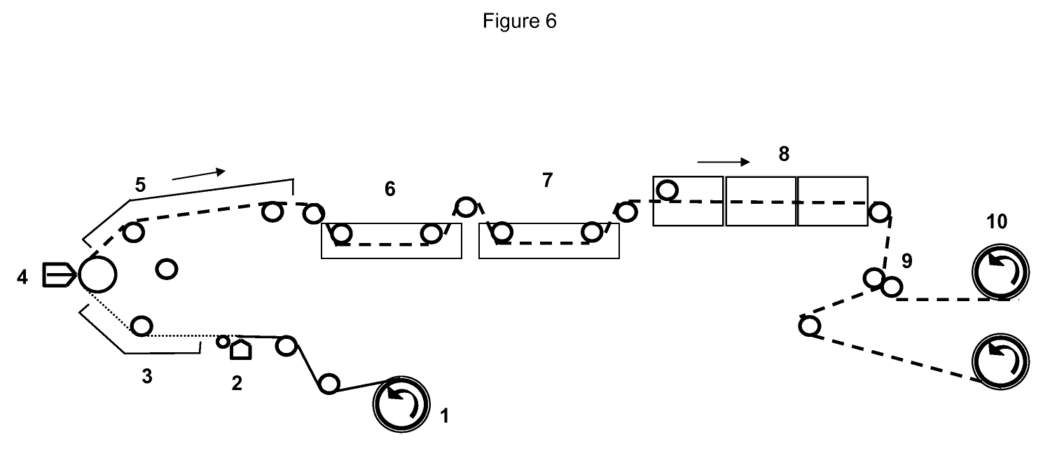

The microstructured mesh may be made in a continuous roll-to-roll process using conventional equipment as shown in FIG. 6. The various stations of the process line are described as follows:

Station 1 is an unwinding element for a roll.

Station 2 is a primer coating station.

Station 3 is a primer drying station.

Station 4 is an emulsion coating station.

Station 5 is an emulsion drying station.

Station 6 is an electroplating bath station.

Station 7 is an acid exposure station

Station 8 is a drying station.

Station 9 is a separating station to separate the mesh from the carrier.

Station 10 is a pair of winding elements for collecting the mesh and the carrier.

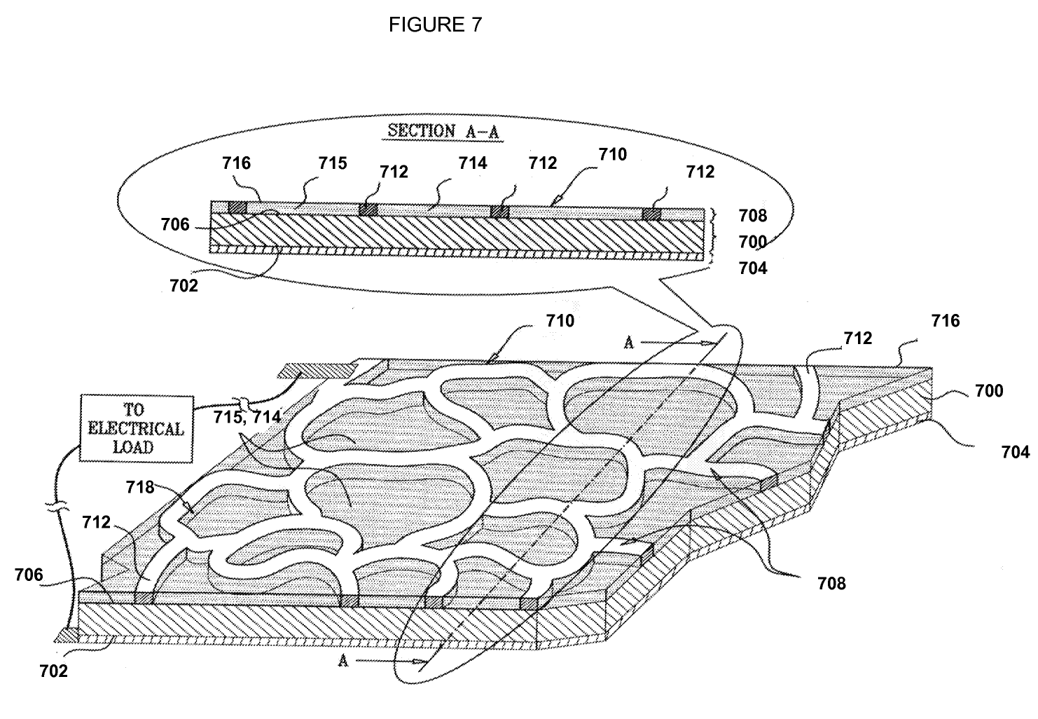

Reference is now made to FIG. 7 which is a simplified diagram of another embodiment of the process for making the microstructured article of the invention and subsequently transferring it a different substrate than the substrate on which it is originally formed. As seen in FIG. 7, a substrate assembly or plurality of substrate assemblies 702 are provided.

Substrate assembly 702 may be flexible or rigid such as glass, paper, ceramic and fabric. Such substrate may include a polymer such as polyester, polyamide, polyimide, polycarbonate, polyolefin, polyacrylate, polymethyl methacrylate (PMMA), a copolymer, or mixtures thereof. The substrate 702 may have a flat surface or a curved surface, and the surface may be smooth or rough.

In order to improve certain properties, the substrate may be pre-treated and/or may have a preliminary coating layer applied prior to the coating of the emulsion formulation. For example, the substrate may have a primer layer to control the mesh coating adhesion, or the substrate may have a hard-coat layer applied in order to provide mechanical resistance to scratching and damage. A primer can also influence the size of the cells in the mesh thereby allowing the mesh to be optimized for certain product applications.

Pretreatment may be performed, for example to clean the surface or alter it by physical means or chemical means. Such means include, but are not limited to, corona, plasma, UV-exposure, laser, glow discharge, microwave, flame treatment, chemical etching, mechanical etching, or printing. Such treatments can be applied to neat substrates or to substrates for which the film supplier has already placed a primer, preliminary coating, or otherwise pretreated the surface of the substrate.

Pretreatment steps can be performed off-line or on-line immediately prior to subsequent coating, printing, and deposition steps. Such physical treatment of the substrate can be performed by batch process equipment or continuous coating equipment, on small laboratory scales or on larger industrial scales, including roll-to-roll processes.

Substrate assembly 702 is supplied to an emulsion coating station 706. At emulsion coating station 706, an emulsion 707 is applied to a surface 710 of the substrate assembly 702.

Emulsion 707 is preferably a water-in-oil emulsion as described above having the nanoparticles dispersed in the organic phase of the emulsion. Mixing of the particles with the desired solvent to form, the dispersion can be accomplished by mechanical stirring, ball mill mixing, and by means of homogenizers or ultrasonic mixing

The nanoparticles are preferably comprised of conductive metals or mixture of metals including metal alloys selected from, but not limited to, the group of silver, gold, platinum, palladium, nickel, cobalt, copper or any combination thereof. Suitable metal nanoparticles include silver, silver-copper alloys, silver palladium or other silver alloys or metals or metals alloys produced by a process known as Metallurgic Chemical Process (MCP), described in U.S. Pat. No. 5,476,535 (“Method of Producing High Purity Ultra-Fine Metal Powder”) and PCT application WO 2004/000491 A2 (“A Method for the Production of Highly Pure Metallic Nano-Powders and Nano-Powders Produced Thereby”). The nanoparticles may be coated or non-coated and may be agglomerated or non-agglomerated.

The emulsion 707 can be applied at emulsion coating station 706 by any suitable technique such as die-coating, bar-coating, screen-printing, ink jet printing, spin-coating, dip-coating, spray-coating, gravure printing, roll-coating, and blade coating. Laboratory-scale or industrial processes can be employed at emulsion coating station 706, utilizing single or multiple pass coating equipment. The emulsion 707 should be applied to the surface 710 of substrate assembly 702 to provide a wet emulsion thickness of 1 to 200 microns and more preferably 5 to 200 microns.

After applying the emulsion 707 to surface 710; the solvent is evaporated from the emulsion 707, with or without the application of heat, as indicated at reference numeral 712. Preferably, the remaining coating is sintered at a temperature within the range of about room temperature to about 850° C. as indicated at reference numeral 714, thereby providing a mesh layer 720 over the surface 710. Sintering preferably takes place at ambient atmospheric pressure.

Alternatively or additionally, all or part of the sintering process indicated at reference numeral 714 can take place in the presence of a chemical that induces the sintering process. Examples of suitable chemicals include formaldehyde or acids, such as formic acid, acetic acid, and hydrochloric acid. The chemical may be in the form of a vapor or a liquid to which the deposited particles are exposed. Alternatively, such chemicals may be incorporated into the composition comprising the nanoparticles prior to deposition, or may be deposited on the nanoparticles after depositing the particles on the substrate.

The process may also include a post-sintering treatment step, as indicated at reference numeral 716, in which the mesh layer 720 may be further sintered, annealed, electroplated as described above, or otherwise post-treated using thermal, laser, UV, acid or other treatments and/or exposure to chemicals such as metal salts, bases, or ionic liquids. The treated mesh layer 720 may be washed with water or other chemical wash solutions such as acid solution, acetone, or other suitable liquids. Post-treatment of the coating can be performed by batch process equipment or continuous coating equipment, on small laboratory scales or on larger industrial scales, including roll-to-roll processes.

Preferred mesh layers 720 are characterized by sheet resistances after sintering between 0.005 Ω/square to 5 kΩ/square, preferably less than 50 ohm/sq, more preferably less than 20 ohm/sq, and most preferably less than or equal to 10 ohm/sq. Sheet resistance is further reduced when mesh layer 720 is electroplated.

It is also a particular feature of the process that formation of mesh layer 320 may employ low temperature deposition and treatment methodologies at temperatures of up to about 350° C. Low temperature liquid phase processing may be carried out at relatively low cost, especially when mesh layers 720 are being formed on large scale surfaces and allow the use of heat sensitive substrates such as certain polymeric substrates.

It is also a particular feature of the process that formation of mesh layer 720 may be controlled in order to get different cell sizes and adjust them to obtain optimum performance for a particular device. For example, the use of a primer on the substrate prior to forming the mesh can alter the cell size.

At mesh removal station 722, mesh layer 720 is separated from substrate assembly 702, forming a separated or free-standing mesh layer 726. Separation of mesh layer 720 from substrate assembly 702 may be accomplished by physical methods such as scraping, peeling, knife separating, and the like. The presence of a release agent or release layer or the absence of an adhesion agent may facilitate removal of mesh layer 720.

The process may also include a deformation step as indicated at reference numeral 728, in which the mesh layer 726 is elongated or deformed so as to change the shape of the cells within the mesh. For example, elongation can orient and increase the aspect ratio of the cells as illustrated by mesh pattern 740.

The separated mesh layer 726 with pattern 720 or 740 may be collected on a roll or transferred to a another substrate 730 for subsequent processing. Additional treatment steps can be carried out as illustrated at reference numeral 736 as described above in connection with reference numeral 716.

The invention may be further illustrated by the following non-limiting examples. In these examples, the mesh is first formed on a substrate in accordance with the methods described in US20050214480 and WO2006/135735 and subsequently processed as described.

### Example 1

A substrate of 4 mil thick polyethylene terepthalate (Toray Lumirror U46) was used.

On the substrate was deposited a layer of primer. The primer consisted of 0.28 wt % Poly[dimethylsiloxane-co-[3-(2-(2-hydroxyethoxy)ethoxy)propyl]methylsiloxane] (Aldrich Cat. No. 480320) and 0.60 wt % Synperonic NP30 (Fluka Cat. No 86209) in acetone solution. The material was mixed by shaking by hand. Approximately 3 ml of material was deposited across one edge of a 8.5″×11″ sample of the substrate material, and drawn down across the film using a wire wrapped rod to generate a nominally 12 micron thick (wet) coating. The sample was allowed to dry in room temperature and room humidity conditions for approximately 1 minute.

An emulsion was prepared by thoroughly mixing the following materials with an ultrasonicating dispersing system.

| Component | % |
|---|---|
| Byk 410 | 0.290% |
| Span 60 | 0.165% |
| Cyclohexanone | 5.212% |
| Aniline | 0.095% |
| Toluene | 58.738% |
| Hexadecanol | 0.796% |
| Cymel 303 | 0.080% |
| K-FLEX XM A307 | 0.248% |
| Nacure 2501 | 0.296% |
| Water phase | 34.080% |
| Total | 100.000% |

The water phase system itself in the table above was comprised of a 0.02% solution (by weight) of BYK 348 in water.

Approximately 3 ml of material was deposited across one edge of a 8.5″×11″ sample of substrate material that had been coated with primer as described above, and drawn down across the film using a wire wrapped rod to generate a nominally 30 micron thick (wet) coating. The sample was allowed to dry in room temperature and room humidity conditions for approximately 90 seconds. It was subsequently placed in an oven at 150° C. for 2 minutes.

The sample was subsequently immersed in an acetone bath for 30 seconds, dried in air for approximately 1 minute, and immersed in a 1M HCl in water bath for 1 minute, rinsed/agitated gently in a water bath for 10 secs, and dried in an oven at 150° C. for 2 additional minutes.

At this stage, a network mesh of metal film on a PET substrate was generated. Subsequent steps allow generation of a free-standing mesh.

An electrolyte bath was prepared by making the following solution listed in percents by mass:

7.00% CuSO₄*5H₂O,

0.029% polyethylene glycol,

0.010% Sodium Dodecyl Sulfate,

9.61% H₂SO₄,

0.021% HCl, and

83.33% deionized water.

This solution was mixed in a 12-quart Prolon Bucket 10 inches in diameter and 12 inches high.

A Mastech HY1803D power supply was placed next to the bath with the negative electrode attached to a flat copper electrode 5 inches wide by 1 inch long, and the positive end attached to a flat copper plate approximately 4 inches wide by 5 inches tall that was used as a counter electrode for a micromesh sample of approximately the same dimensions.

A sample of microstructured mesh on a substrate was attached along the top edge to the negative copper electrode with clamps and lowered nearly completely into the electrolyte solution to a depth such that the electrode clamping piece (5″×1″ copper) was just short of making contact with the plating bath (with approximately 5 mms of mesh outside of the plating bath). The positive electrode plate was then submerged in the electrolyte solution.

After both electrodes were submerged, the power supply was activated at a steady current of 1.01 amps for 10 or 15 minutes depending on the desired resistance. Samples that were plated for 10 minutes were taken out of the bath after the first five minutes of plating, disconnected from the clamps, and inverted (top to bottom), reclamped, and plated again to provide better plating thickness uniformity, while samples that were plated for 15 minutes were inverted after 7.5 minutes. The coated substrate was then removed from the bath, washed by running tap water over the sample for less than a minute, and allowed to dry in air.

To remove the electroplated coating from the substrate, the sample was placed in a solution of 10% sulfuric acid overnight. The layer was then slowly peeled off by hand. The resistances of the microstructured mesh sheets before electroplating were approximately 5 ohms/square, while the resistance ranges for the 10 and 15 minute electroplated samples after plating were 0.1-0.2 and 0.06-0.1 ohms/square respectively.

### Example 2

A mesh was generated on a glass substrate. The mesh and substrate were immersed in a bath of 5% hydrofluoric acid in water for 1 minute at room temperature, taken out of the bath, rinsed with tap water for less than a minute. The metal mesh was peeled from the substrate by hand.

What is claimed is:

1. A microstructured article comprising a free-standing network of interconnected traces surrounding randomly-shaped cells wherein the interconnected traces comprise at least partially-joined nanopartilces.

2. The article of claim 1 wherein the nanoparticles comprise a metal.

3. The article of claim 1 where the network has a sheet resistance less than 10,000 ohms/sq.

4. The article of claim 1 wherein the network has a cell size between one square micron and one square millimeter.

5. The article of claim 1 where the traces are less than 100 microns wide and less than 100 microns thick.

6. The article of claim 1 wherein the traces comprise a coating thereon.

7. The article of claim 6 wherein the coating is formed by electroplating.

8. The article of claim 6 wherein the coating comprises a passivating material.

9. The article of claim 8 wherein the passivating material is an oxide or an organic coating

10. The article of claim 1 wherein the article comprises at least two major surfaces, and one major surface has a smoother topography than another major surface.

11. The article of claim 1 wherein the article comprises at least two major surfaces and one major surface is a different color than another major surface.

12. A process for making the microstructured article of claim 1 comprising:
a) forming a network of interconnected traces comprising nanoparticles surrounding randomly-shaped cells on the surface of a substrate by self assembly of the nanoparticles from an emulsion;
b) electroplating the network;
c) exposing the network to an acid to release the network from the substrate; and
d) removing the network from the substrate.

13. The process of claim 12 wherein the emulsion comprises a water-in-oil emulsion and the oil phase comprises an organic solvent having nanoparticles dispersed therein.

14. The process of claim 12 wherein the network is transferred to a second substrate after removal from the substrate on which it was formed.

15. A process for making the microstructured article of claim 1 comprising:
a) forming a network of interconnected traces comprising nanoparticles surrounding randomly-shaped cells on the surface of a substrate by self assembly of the nanoparticles from an emulsion;
b) separating the network from the substrate by mechanical means; and
c) collecting the separated network on a roll.
